(19) United States
(12) Patent Application Publication
(10) Pub. No.: US 2021/0278555 A1
(43) Pub. Date: Sep. 9, 2021

(54) Radiation Sensing Pixel Element for an Image Sensor Apparatus

(71) Applicants: IMEC VZW, Leuven (BE); Katholieke Universiteit Leuven, KU LEUVEN R&D, Leuven (BE)

(72) Inventors: Florian De Roose, Leuven (BE); Rainer Kuth, Weisendorf (DE); Soeren Steudel, Oud-Heverlee (BE); Sandro Francesco Tedde, Hochstadt (DE)

(21) Appl. No.: 16/332,592

(22) PCT Filed: Aug. 30, 2017
(86) PCT No.: PCT/EP2017/071698

§ 371 Date: Mar. 12, 2019

(30) Foreign Application Priority Data
Sep. 12, 2016 (EP) 16188363.2

(51) Int. Cl. G01T 1/24; H04N 5/32; G01T 1/20

(52) U.S. Cl. CPC G01T 1/247; G01T 1/2018; H04N 5/32

(57) ABSTRACT

An example includes sensing radiation with a photo diode; storing, in a pixel capacitor electrically coupled to the photo diode, electric charge supplied by the photo diode in response to the sensed radiation; providing a pixel amplifier output signal at an output link of a pixel amplifier having an input link electrically coupled to the pixel capacitor, where the pixel amplifier output signal depends on an amount of the electric charge stored in the capacitor; providing, to analyzing circuitry of the image sensor apparatus, a pixel output signal at a pixel output link of the radiation sensing pixel element by a pixel selector transistor, the pixel output signal being dependent on the pixel amplifier output signal and a selector control signal provided by the analyzing circuitry; and controlling a gain defining a dependency between the pixel output signal and the amount of the electric charge stored in the capacitor.

### CROSS-REFERENCE TO RELATED APPLICATIONS

The present application is a national stage application claiming priority to International Patent Application No. PCT/EP2017/071698 filed Aug. 30, 2017, which claims priority to European Patent Application No. 16188363.2, filed Sep. 12, 2016, the contents of both of which are hereby incorporated by reference.

### FIELD OF THE DISCLOSURE

The present disclosure generally relates to a radiation sensing pixel element for an image sensor apparatus.

### BACKGROUND

Some image sensor apparatuses and radiation sensing pixel elements, as well as methods for their operation, are known. Image sensor apparatuses are generally used in the technical field of surveying quality of materials, in the field of exploration or examination in the medical field, especially clinical diagnostics, and/or the like. They are often used to detect or sense electromagnetic radiation, especially x-rays, but also to detect ionizing radiation, e.g., based on electrons or other particles forming atoms. However, a broad field is formed by clinical diagnostics based on x-rays.

X-ray absorption of metallic objects in a human body is typically very high compared with tissue of the human body, especially tissue surrounding the metallic object. A metallic object may get into the human body as an implant during, e.g., orthopedic surgery curing fractures of bones or the like. During such a surgery, at the end of such a surgery, as well as in predefined periods after the surgery, clinical diagnostics are typically provided in order to monitor a progress of a result of the surgery. Usually, a clinical diagnostic is provided by 2D or 3D x-ray-imaging in order to analyze, e.g., a proper position of the implant, for instance, checking whether a bone-screw is too long or too short. Another approach deals with medical diagnostics in order to examine severe traumas caused, e.g., by bullets, fragments of explosions, and/or the like.

At present, x-ray medical imaging is generally not well suited to depict extremely high contrasts caused by the previously mentioned objects contained in a human body. For example, in 2D-x-ray-imaging, the foreign object in the human body may absorb almost the complete x-ray radiation so that a detector or the array of radiation sensing pixel elements cannot detect any tissue contrast within a shadow of this object. In a 3D-x-ray-imaging, the imaging system may fail to acquire a huge amount of raw data along beam-lines. As a consequence, such respective 3D datasets are incomplete and algorithms applied to such datasets deliver significant image artifacts which are hardly to be interpreted by a respective operator or medical practitioner.

However, good image data is usually important in the neighborhood of the implant or object because a surgeon will generally require a lot of information from this area to help ensure an effective procedure.

Some approaches have been developed to help address these deficiencies. According to a first approach, the array of the radiation sensing pixel elements is also known as matrix detector. Traditional matrix detectors comprise pixels where respective pixel capacitors are discharged by the photo diode when the photo diode is subjected to radiation. Such pixels are also known as passive pixels or passive pixel elements. During read-out of a certain pixel capacitor, the previously discharged pixel capacitor is filled again with electric charge and the amount of the electric charge supplied to the pixel capacitor is determined. Consequently, such passive pixels generally cannot be read twice. Therefore, in order to create a high-dynamic range image, two images are recorded by the matrix detector, e.g., a first image based on a high dose of x-rays and a second image based on a low dose of x-rays, or two consecutive doses, wherein a first read-out has a high gain and a second read-out has a low gain. Afterwards, the two resultant images are combined in order to achieve a high-dynamic range image. This is disclosed, e.g., by U.S. Pat. No. 9,230,311 B2. This is also referred to as passive pixel scheme (PPS).

Another approach for improving the dynamic range of an image based on x-ray matrix detectors uses two different pixel capacitors in each pixel which is connected with respective different gain settings in each pixel which is disclosed by U.S. Pat. No. 9,106,851 B2 as well as WO 2009/156 927 A2. However, these methods can require substantial intervention in the construction of the radiation sensing pixel element and, moreover, increasing dimensions of the radiation sensing pixel element because additional capacitors generally have to be integrated with the radiation sensing pixel elements. These require respective space. Consequently, these technologies affect also the resolution of the image sensor apparatus.

However, these approaches can suffer due to the substantial changes to each of the radiation pixel sensor elements, as the changes can introduce a lot of heavy and expensive additional components and, in fact, they can affect the dimensions of each of the radiation sensing pixel elements even further because such radiation sensing pixel elements typically take up more space.

### SUMMARY

Consequently, it is a potential benefit of the disclosure to help improve imaging technology such that an enhanced contrast can be achieved, especially in the vicinity of implants, objects, or the like surrounded by human tissue in order to provide reliable image information about that vicinity to a surgeon.

The present disclosure relates to a radiation sensing pixel element for an image sensor apparatus having an array of radiation sensing pixel elements, wherein the radiation sensing pixel element comprises: a photo diode in order to sense radiation; a pixel capacitor connected with the photo diode in order to store electric charge supplied by the photo diode when the photo diode is subjected to the radiation; a pixel amplifier having an input link connected with the pixel capacitor and an output link, wherein the pixel amplifier is configured to provide a pixel amplifier output signal at the output link dependent on an amount of the electric charge stored in the pixel capacitor; a pixel selector transistor having a first, a second, and a third link, wherein the first link is connected with the output link of the pixel amplifier and the second link forming a pixel output link that is adapted to be connected with an analyzing circuitry of the image sensor apparatus, wherein the pixel selector transistor is configured to provide a pixel output signal at the pixel output link dependent on the pixel amplifier output signal and a selector control signal of the analyzing circuitry provided at the third link in order to supply the pixel output signal to the analyzing circuitry.

The disclosure further relates to an image sensor apparatus including an array of radiation sensing pixel elements and an analyzing circuitry for analyzing pixel output signals of the radiation sensing pixel elements, wherein the analyzing circuitry is connected with the array of the radiation sensing pixel elements.

Finally, the disclosure relates to a method for operating a radiation sensing pixel element of an array of radiation sensing pixel elements of an image sensor apparatus, wherein the method comprises: sensing radiation with a photo diode; storing electric charge supplied by the photo diode, when the photo diode is subjected to the radiation, in a pixel capacitor connected with the photo diode; providing a pixel amplifier output signal at an output link of a pixel amplifier having an input link connected to the pixel capacitor, wherein the pixel amplifier output signal depends on an amount of the electric charge stored in the pixel capacitor, and providing a pixel output signal at a pixel output link of the radiation sensing pixel element by a pixel selector transistor dependent on the pixel amplifier output signal and a selector control signal of an analyzing circuitry of the image sensor apparatus in order to supply the pixel output signal to the analyzing circuitry.

The disclosure also includes a radiation sensing pixel element, an image sensor apparatus, and a method for operating a radiation sensing pixel element, e.g., according to the independent claims.

With regard to a generic radiation sensing pixel element, the disclosure teaches that the radiation sensing pixel element can be configured to control a gain defining the dependency between the pixel output signal and the amount of the electric charge stored in the pixel capacitor.

With regard to a generic image sensor apparatus, the disclosure teaches that the array can include radiation sensing pixel elements according to the disclosure.

With regard to a generic method, the disclosure teaches controlling a gain defining the dependency between the pixel output signal and the amount of the electric charge stored in the pixel capacitor.

The disclosure teaches that the gain can be adjustable in a certain pixel. For this purpose, a pixel related gain can be defined so that the contrast can be improved. So, it is not only possible to provide images from objects having high contrast to differences in a single picture but it is also possible to reduce the required radiation in order to achieve a sufficient imaging by the image sensor apparatus. This is especially a potential advantage with regard to clinical diagnostics of human bodies where the exposure of x-rays should be as limited as possible in order to avoid an undesired effect caused by x-rays. Embodiments of the disclosure do not require changing a capacity of the pixel capacitor, an integration time, and/or the like. Instead, some embodiments involve controlling the gain which defines the dependency between the pixel output signal and the amount of the electric charge stored in the pixel capacitor.

The gain can be controlled by components which are comprised by the radiation sensing pixel element. Especially, components can be used for adjusting or controlling the gain which are already comprised by generic radiation sensing pixel elements. Therefore, additional components in the radiation sensing pixel element can be avoided. This allows applying the teachings of the disclosure also to present constructions of radiation sensing pixel elements and image sensor apparatuses as well. Only minor adaptations may be necessary so that dimensions of the radiation sensing pixel elements can be maintained so that negative effects on the resolution of imaging can be avoided.

The radiation sensing pixel element can be provided for sensing x-rays. But generally, it can also be applied to radiation sensing pixel elements which are adapted to sense light, especially visible light, or the like. In this regard, the radiation sensing pixel element can also be combined with a scintillator which usually comprises a material that exhibits scintillation, a property of luminescence, when excited by high energy radiation or ionizing radiation. Moreover, the radiation sensing pixel element may be applied to particle radiation such as α-rays, β-rays, and/or the like.

In this regard, the array of the radiation sensing pixel elements can provide a respective plurality of pixel output signals which are analyzed by the analyzing circuitry in order to result in image data forming a data set. In this regard, the image sensor apparatus can operate as a detector for a certain radiation in order to provide image data which can be displayed on a display to an operator, store respective datasets for later use, and/or the like.

For this purpose, the image sensor apparatus may include a control module controlling the operation of the components of the image sensor apparatus, e.g., the analyzing circuitry and the array of the radiation sensing pixel elements. Moreover, the control module may contain a storage unit, e.g., in order to store data received from the array of the radiation sensing pixel elements. The image sensor apparatus may also comprise an interface adapted to be connected with, e.g., a communication line or a communication network such as the Internet in order to supply the dataset to a remote computer, for example, a computer of an operator, or the like.

The teachings of the disclosure generally avoid the disadvantages discussed above because additional space requiring capacitors are not necessary. The disclosure basically deals with the components and the structure which are already present in a generic radiation sensing pixel element.

The photo diode serves to sense the radiation for which the radiation sensing pixel element is designed. The photo diode may preferably be a semiconductor component. Although the disclosure is based on the use of a photo diode, other photon or ionizing particle sensing elements can also be used in order to replace the photo diode without affecting the scope of the disclosure, for example, a phototransistor, a photocell, and/or the like.

The photo diode exhibits a voltage between its anode and its cathode, wherein a current flow depends on the amount of the radiation. Consequently, the pixel capacitor is generally charged by the photo diode depending on the amount of the radiation sensed by the photo diode.

For a radiation sensing pixel element which is adapted to be sensitive for x-rays, a dose of x-rays generates a certain electric charge in the pixel capacitor. This charge re-presents a radiation density at the photo diode. Analyzing all charges of all pixel capacitors of all of the radiation sensing pixel elements of the array therefore allows reconstructing the material arranged between the radiation source and the image sensor apparatus. So, an image of the material can be provided.

In order to receive data representing an image, a pixel output signal can be supplied to the analyzing circuitry which depends on the electric charge stored in the pixel capacitor related to this dose. For this purpose, the pixel amplifier is provided which has an input link connected with the pixel capacitor. Moreover, the pixel amplifier has an output link providing a pixel amplifier output signal which depends on the amount of the electric charge stored in the pixel capacitor. Preferably, the operation of the pixel amplifier does not substantially affect the electric charge of the pixel capacitor. So, undesired effects on the electrical charge of the pixel capacitor can substantially be reduced in order to reduce mistakes. The pixel amplifier is a component of the radiation sensing pixel element. Therefore, the radiation sensing pixel element contains a pixel amplifier.

In order to provide controlled read-out of the radiation sensing pixel element, the radiation sensing pixel element further comprises the pixel selector transistor. The pixel selector transistor is connected with the output link of the pixel amplifier in order to receive the pixel amplifier output signal. Moreover, the pixel selector transistor forms a pixel output link of the radiation sensing pixel element which is adapted to be connected with the analyzing circuitry of the image sensor apparatus. So, by controlling the pixel selector transistor, a respective signal of the pixel amplifier can be switched onto a data line to supply the pixel output signal to the analyzing circuitry. The pixel selector transistor is controlled by a selector control signal of the analyzing circuitry which helps ensure that a predetermined number of the radiation sensing pixel elements of the array provide their pixel output signal to the analyzing circuitry.

A pixel selector transistor is traditionally operated in a switch mode. The switch mode allows the pixel selector transistor to operate like a switch controlled by the selector control signal. Depending on an electric potential of the selector control signal, the pixel selector transistor provides for two statuses, namely, a switched-on-status and a switched-off-status. These electrical potentials are chosen such that a controllable connection between the first link and the second link of the pixel selector transistor can be switched from low resistance to high resistance and vice-versa. The status of the pixel selector transistor generally depends directly on the electric potential provided at the third electrode of the pixel selector transistor which is provided by the selector control signal. In this regard, traditionally, the pixel selector transistor is operated in the switch mode only.

Further, the radiation sensing pixel element is configured to control the gain defining the dependency between the pixel output signal and the amount of the electric charge stored in the pixel capacitor. Considering the above, there are a few options for controlling the gain in order to adjust the contrast such that a high-dynamic range image can be achieved. The disclosure focuses on the pixel amplifier and the pixel selector transistor, which are components that are present in the radiation sensing pixel element and which can be used for controlling the gain. However, it is also possible to provide additional components which allow for adjusting the gain according to the disclosure. For example, the pixel amplifier can contain an operational amplifier including a respective network that adjusts its amplifying factor in order to provide the gain. The gain control signal acts on the network in order to control the gain of the pixel amplifier.

In contrast to the passive pixel scheme (PPS) discussed above, the active pixel scheme (APS) involves the pixel capacitor being charged by the photo diode when exposed to radiation. The charge of the pixel capacitor is read-out, and after having read-out the electric charge of the pixel capacitor, a reset element discharges the pixel capacitor so that the radiation sensing pixel element is ready for a new sensing term. The reset element can take the form of a reset transistor which may be also be controlled based on the selector control signal of the analyzing circuitry. For example, discharging of the pixel capacitor may be triggered by finishing the read-out procedure. The active pixel scheme allows an in-pixel amplification that can result in a noise reduction and an increased speed of operation.

For image sensor apparatuses adapted for use with x-rays, the concepts of the disclosure can be used to provide an active, medical-grade, high resolution, high dynamic range x-ray backplane based on a-IGZO (amorphous indium gallium zinc oxide) thin-film technology with fast read-out. This can enable low dose video rate x-ray imaging. a-IGZO is a semiconductor material which comprises substantially indium, gallium, zinc, and oxygen. An IGZO thin-film-transistor (TFT) is typically used in TFT-backplanes of flat-panel displays (FPD). An IGZO-TFT generally has an electron mobility which is 20 to 50 times higher than that of amorphous silicon, also referred to as a-Si, which is often used in liquid-crystal displays (LCD) as well as e-papers, and the like. As a result, IGZO-TFT can improve the speed, the resolution as well as the size of flat-panel displays. One potential benefit of using IGZO over zinc oxide is that it can be deposited as a uniform amorphous phase while retaining the high carrier mobility common to oxide semiconductors. The concepts of the disclosure can be applied to such materials but it is not limited thereto.

Reducing x-ray doses for medical imaging has long been a goal for research. For large-area digital imaging, such as chest x-ray, mammography, or the like, the technology has been generally limited to flat-panel display technology (FPD) on glass using a-Si for cost reasons. A passive pixel scheme can be used having only one access transistor per pixel which imposes stringent requirements on an external read-out integrated circuit (ROIC) or the analyzing circuitry, respectively. A modified pixel design approach can lead to a relaxed specification for the ROIC without compromising performance, and resulting in a more cost-affected x-ray image sensor apparatus.

Especially, when a-IGZO-thin-film technology is used, active amplification of the pixel output signal can be achieved within each radiation sensing pixel element. Such a backplane technology supports critical dimensions (CD) down to about 3 μm or less.

Active amplification inside of a radiation sensing pixel element generally allows increasing both the operational speed and the dynamic range of a pixel by buffering and reducing data line noise. Moreover, further improvement can be achieved considering low mobility of the charge carriers and large data line capacitance by thin-film active pixel schemes operating in a current mode.

Therefore, according to a further aspect, the disclosure teaches that the radiation sensing pixel element can be configured to provide an electric current as the pixel output signal. Consequently, the radiation sensing pixel element operates in a current mode. One potential benefit of the current mode is that an input signal, i.e., the charge of the pixel capacitor, is converted into a current by the pixel amplifier which can be read-out by the ROIC. Therefore, an important measure of merit is the gain defining the dependency between the pixel output signal and the amount of the electric charge stored in the pixel capacitor, here a charge-to-current gain (CtC-gain), namely, a ratio between the increase of the output current divided by a change in the charge of the pixel capacitor. The concepts of the disclosure can help in achieving a CtC-gain of about 50 μA/pC, or higher. It is possible to increase the CtC-gain while at the same time decreasing a minimum transistor length of the technology.

According to an embodiment, the radiation sensing pixel element comprises a gain control link configured to receive a gain control signal. The gain control signal is provided by the analyzing circuitry or, alternatively, by the control module of the image sensor apparatus. The gain control signal allows adjusting the gain of the radiation sensing pixel element in order to improve the dynamic of the radiation sensing pixel element. However, the gain control signal can alternatively be provided by the radiation sensing pixel element itself, for example, by measuring a saturation of the pixel amplifier and reducing an amplification factor respectively by the gain control signal in order to leave the saturated mode of the pixel amplifier, or the like.

According to an embodiment, the pixel amplifier is connected with the gain control link and is configured to adjust an amplification factor dependent on the gain control signal. This feature allows varying the gain via an external signal with regard to the radiation sensing pixel element. The analyzing circuitry provides a respective gain control signal when reading-out the respective radiation sensing pixel element. So, individual adjustment of the gain can be achieved so that a high resolution combined with a high dynamic range can be achieved. The external instance providing the gain control signal has at the same time the information about the gain so that this information can be used for adapting and interpreting the read-out data of the radiation sensing pixel element.

In an embodiment, the pixel amplifier comprises an amplification transistor. This can provide a compact and simple radiation sensing pixel element, especially, by use of the before-mentioned technologies, in order to allow manufacturing of a matrix comprising the array of radiation sensing pixel elements by use of the before-mentioned technologies. Preferably, the amplification transistor is formed by a field effect transistor because a field effect transistor (FET) generally has a high input resistance so that during its operation the charge of the pixel capacitor is not substantially altered. Moreover, FETs are generally easy to produce using thin-film technologies, especially, the technologies discussed above.

According to a further embodiment, the pixel amplifier is connected with a ground level that is provided by the radiation sensing pixel element, wherein an electric potential of the ground level is controlled by the gain control signal, wherein the pixel amplifier is configured to adjust the amplification factor dependent on the electric potential of the ground level. In this regard, adjusting the amplification factor can result in adjusting the gain of the pixel amplifier. This embodiment can be useful not only for general purpose amplifiers, but also for embodiments using an amplification transistor, especially an FET for the purpose of amplification inside the radiation sensing pixel element. So, the ground level can be used for adjusting the amplification factor. Especially if an FET is used, the ground level can be connected with a source of the FET. Varying the electric potential of the ground level leads to varying of a gate-source-voltage which determines an operating point of the FET which, in turn, affects the amplification factor, and finally the gain. The FET can be formed by a metal oxide semiconductor field effect transistor (MOSFET).

According to another embodiment, the pixel amplifier is configured to control a first operating point of the amplification transistor based on the gain control signal. So, the pixel amplifier may comprise additional circuitry which influences the first operating point of the amplification transistor. In this way, a further possibility of controlling the gain can be derived. If the pixel amplifier is formed by a single amplification transistor, the amplification factor can be influenced by providing a bias voltage at a control electrode of the amplification transistor which is a gate electrode when the amplification transistor is formed by a FET. As the amplification factor depends on the first operating point, the gain can be adjusted.

In an embodiment, the amplification transistor has a separate control electrode which the gain control signal acts on in order to control the first operating point. This allows adjusting the first operating point of the amplification transistor in a potentially beneficial way because an electric coupling to the pixel capacitor can be omitted. A nearly independent adjustment of the first operating point can be achieved.

According to an embodiment, the pixel output signal is formed by the electric current and the radiation sensing pixel element is configured to control the first operating point of the amplification transistor by a voltage supplied to the pixel output link. As the pixel output signal is formed by the electric current which is mainly independent from a voltage on the pixel output link, a voltage can additionally be applied to the pixel output link which can be used for controlling the gain of the radiation sensing pixel element. This voltage can form the gain control signal. Therefore, the image sensor apparatus does not need to provide additional wiring in order to enable control of the gain of a certain radiation sensing pixel element. If the amplification transistor is provided, the voltage of the pixel output link can directly act on the gate of the amplification transistor(e.g., the FET). This can allow control of the gain of the radiation sensing pixel element.

According to another embodiment, the pixel selector transistor is configured to be operated at least partially in a linear operating mode in response to the gain control signal. Preferably, the traditional switch mode is replaced by a combined mode which allows providing the switch-off state when the analyzing circuitry does not read-out the respective radiation sensing pixel element. The traditional switch-on state can be replaced by a linear operating mode so that the pixel selector transistor provides a certain resistance controllable by the gain control signal that affects the gain of the radiation sensing pixel element. This option can be provided instead of controlling the amplification factor of the pixel amplifier or it can be combined therewith.

The pixel selector transistor can be connected to the amplification transistor such that the first operating point of the amplification transistor is controlled by the pixel selector transistor. In this regard, the pixel selector transistor can, for example, be connected with the source electrode of the FET, wherein adjustment of the pixel selector transistor in the on-state leads to corresponding adjustment of its resistance which affects the gate-source-voltage of the FET as amplification transistor so that the operating point of the amplification transistor can be adjusted in order to achieve the desired gain.

The radiation sensing pixel element can be configured to adjust a second operating point of the pixel selector transistor based on the gain control signal. In this embodiment, the pixel selector transistor provides the respective gain as desired. The pixel amplifier need not be influenced. However, an additional control of the amplification factor of the pixel amplifier can be provided.

The pixel selector transistor can also be formed by a FET. Alternatively, the pixel selector transistor can also be formed by a bipolar transistor or the like. However, with regard to power consumption and control expense, the FET has some potential advantages when compared to bipolar transistors. Because the control energy may be extremely small for an FET with regard to bipolar transistor and the range of the control voltage may be much broader than that of a bipolar transistor, a respective control signal for the FET may be much simpler than for a bipolar transistor.

Aspects as discussed with regard to the radiation sensing pixel element can be also applied to the image sensor apparatus and the method for operating the radiation sensing pixel element as well.

### BRIEF DESCRIPTION OF THE FIGURES

The above, as well as additional, features will be better understood through the following illustrative and non-limiting detailed description of example embodiments, with reference to the appended drawings.

FIG. 1 is a schematic diagram of a radiation sensing pixel element forming a portion of a circuitry of an array comprising a plurality of radiation sensing pixel elements according to a passive pixel schematic, according to an example embodiment;

FIG. 2 is a schematic block diagram showing components of an x-ray imager system comprising a TFT array forming a plurality of radiation sensing pixel elements, according to an example embodiment;

FIG. 3 is a schematic diagram of a portion of the TFT array of FIG. 2 with regard to a single radiation sensing pixel element of the array, according to an example embodiment;

FIG. 4 is a schematic diagram of circuitry of the array of four radiation sensing pixel elements of FIG. 3 showing an interconnection within the array, according to an example embodiment;

FIG. 5 is a schematic diagram of a radiation sensing pixel element based on a passive pixel scheme, according to an example embodiment;

FIG. 6 is a schematic diagram showing signaling of the radiation sensing pixel element according to FIG. 5, according to an example embodiment;

FIG. 7 is a schematic block diagram of a radiation sensing pixel element operating in a current mode, according to an example embodiment;

FIG. 8 depicts an alternative embodiment of a radiation sensing pixel element, according to an example embodiment;

FIG. 9 is a schematic diagram of a single radiation sensing pixel element according to an active pixel scheme and using the current mode according to FIG. 7 or FIG. 8, according to an example embodiment;

FIG. 10 is a schematic signaling diagram for the radiation sensing pixel element according to FIG. 9, according to an example embodiment;

FIG. 11 is a schematic read-out scheme for reading out the radiation sensing pixel element two times between two consecutive resets, according to an example embodiment;

FIG. 12 is a schematic diagram for an alternative radiation sensing pixel element according to the active pixel scheme in a current mode with regard to FIG. 9, according to an example embodiment;

FIG. 13 is a schematic diagram for an amplification transistor formed by a field effect transistor which has a dual gate construction, according to an example embodiment;

FIG. 14 is a schematic diagram showing the dependency of a drain current of the field effect transistor according to FIG. 13 dependent on different gate voltages at both of the gates of the field effect transistor of FIG. 13, according to an example embodiment;

FIG. 15 is a schematic diagram of a read-out integrated circuit using correlated double sampling, according to an example embodiment;

FIG. 16 is a schematic time diagram and connected block diagram for the read-out integrated circuit according to FIG. 15, according to an example embodiment;

FIG. 17 a schematic block diagram showing functional blocks of an image sensor apparatus using radiation pixel sensor elements, according to an example embodiment; and

FIG. 18 is a schematic diagram of a radiation sensing pixel element using a dual gate field effect transistor according to FIG. 13 based on a circuitry structure according to FIG. 12, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

Adjusting a dynamic range of a sensor read-out can be a useful feature for many applications. For example, multiple options can be implemented in a CMOS imager or other type of CMOS sensor arrays for an image sensor apparatus. One implementation relates to adjusting an exposure time or adding an external reduction in dose. CMOS integration generally allows complex pixel engines and complex read-out schemes for arrays of radiation sensing pixel elements. Moreover, a frame rate and/or a read-out speed can be adjusted by several orders of magnitude. Preferably, an active pixel scheme is implemented that allows an in-pixel amplification which can result in a reduction of noise and an increasing of the speed. In this regard, a compromise between speed, noise, linearity, range, and cost can be achieved. However, limitations can be given by a size of the radiation sensing pixel element, a size of a pixel capacitor and/or a voltage range, especially having in view that available supply rails in CMOS-technology can allow voltages between 0.9 V to 5 V depending on the technology node.

In large area sensor read-outs made in thin-film-transistor-technology, such as, e.g., a-Si, metal oxide or low-temperature poly-silicon (LTPS), there may appear additional limitations on the complexity of a suited read-out scheme and pixel design. Traditionally used passive pixel (1T1C)-technologies are implemented, since a-Si-TFTs have a low mobility and a low bias stability. TFT's based on LPTS have a higher mobility and a better bias stability but may suffer from un-uniformity and high leakage current detrimental to a sensor array. Therefore, for large area sensor arrays having a plurality of radiation sensing pixel elements, especially for image sensor apparatuses for x-rays, an increased dynamic range can be achieved by the using the examples of this disclosure.

An image sensor apparatus 10 is shown in FIG. 2. FIG. 2 shows a schematic block diagram of a portion of the image sensor apparatus 10 having an array of radiation sensing pixel elements 30 forming a TFT-array 12 including a photo detector and a scintillator which are not shown in FIG. 2. Presently, the TFT-array 12 has dimensions in the plane of about 20 cm in one of two orthogonal directions and 30 cm in the other orthogonal direction. The TFT-array 12 forms a flat rectangular component of the image sensor apparatus 10. The TFT-array 12 is arranged on a framework 62 contacting the photo detectors which are formed by the radiation sensing pixel elements 30. For this purpose, gate-select-lines 58 as well as read-out-lines 60 are provided in order to allow a selected read-out of each of the radiation sensing pixel elements 30 of the TFT-array 12.

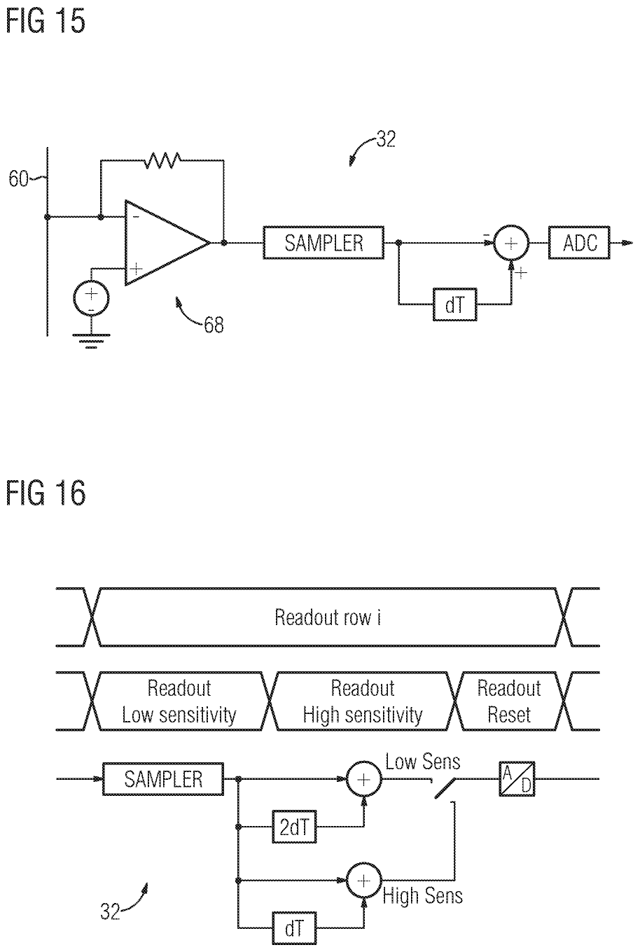

The framework 62 further has a flex-bond wiring 54 that connects all of the gate-select-lines 58 and the read-out-lines 60 with a distal arranged analyzing circuitry 32 (FIG. 15) of the image sensor apparatus 10. The flex-bond wiring 54 provides therefore electrical connection.

X-ray machines, such as the image sensor apparatus 10, are widely used to investigate a status of a tissue and/or a bone in a human body or the like. X-ray absorption of different objects depends on the density and a capture cross-section of the analyzed materials or tissues, respectively. Therefore, a performance indicator of the x-ray machine may be the lateral resolution as well as the achievable dynamic range or contrast, respectively. Furthermore, energy and duration of a required x-ray pulse, also referred to as dose or shot, should generally remain as low as possible.

Digital x-ray imagers are often limited with regard to their dynamic range when neighboring materials (e.g., a screw in a bone) have a high difference in absorptivity, e.g., several orders of magnitude. Either, the bone and the surrounding tissue can be imaged with high contrast and the screw is left simply as a black portion or the screw can be imaged with high contrast and the surrounding bones and tissues are simply white. Therefore, a need exists to increase the dynamic range of image sensor apparatuses, such as the image sensor apparatus 10.

An x-ray machine usually comprises an x-ray source and a digital imager, such as the image sensor apparatus 10. For many applications, e.g., mammography or the like, the image sensor apparatus 10 is made on glass comprising an active matrix array 12 of thin-film transistors, such as pixel selector transistors 26, thin-film photo diodes 16 as well as a scintillator layer. Although, a plurality of different array sizes is possible, a common size is 20 cm×30 cm with a pitch of 100 μm. A manufacturing process can be similar to the manufacturing process for manufacturing of flat-panel displays (e.g., LCD displays).

Although many materials can be used for producing the array 12, for example a-Si or the like, in some embodiments the use of a metal oxide semiconductor material such as an IGZO material is useful because it can present a high mobility, a low off current, and a high bias stability.

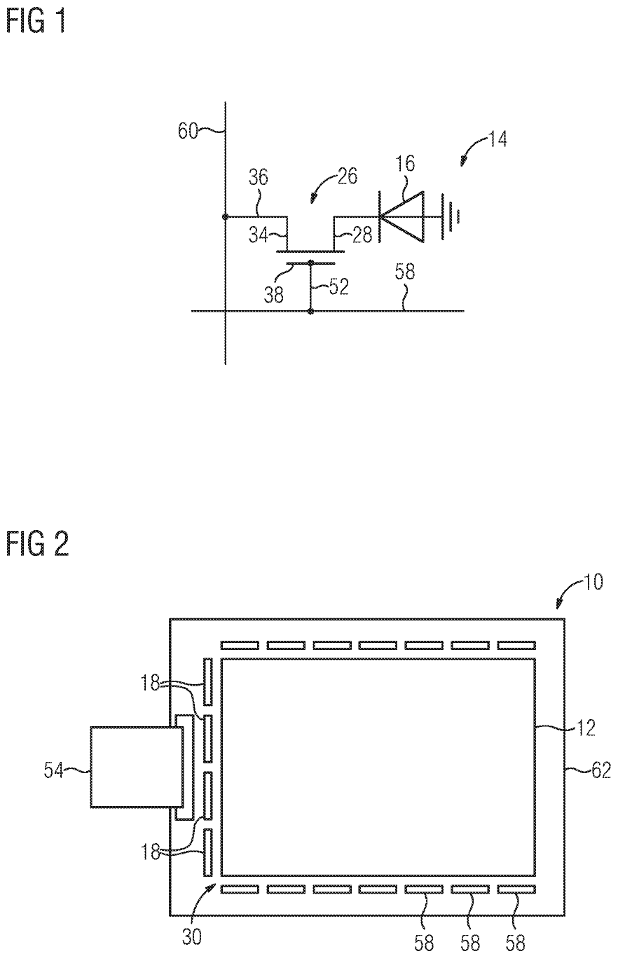

FIG. 1 shows a portion of the array 12, namely, a single x-ray sensing pixel element 14 as known in the art based on PPS. The x-ray sensing pixel element 14 comprises a photo diode 16 which is connected with a pixel selector transistor 26. The photo diode 16 is sensitive to x-rays and provides respective electric charge when the photo diode 16 is subjected to the x-rays forming the radiation in this embodiment. Not shown in FIG. 1 is an integration capacitance which is usually also comprised by the x-ray sensing pixel element 14 of FIG. 1.

The pixel selector transistor 26 is provided by a certain field effect transistor, namely, a metal oxide semiconductor field effect transistor (MOSFET). The pixel selector transistor 26 comprises three links 28, 34, 38. A first link 28 is connected with an anode of the photo diode 16. The second link 34 which forms a pixel output link 36 at the same time, is adapted to be connected with the analyzing circuitry 32 of the image sensor apparatus 10. For this purpose, the second link 34 is connected to a dataline 60 which, in turn, is connected with the analyzing circuitry 32. In this regard, the x-ray sensing pixel element 14 can be read-out by the analyzing circuitry 32. As a plurality of x-ray sensing pixel elements 14 are connected with the dataline 60, respective pixel selection is required, in order to allow read-out of each single x-ray sensing pixel element 14. For this purpose, the pixel selector transistor 26 is configured to provide a pixel output signal at the pixel output link 36 dependent on a selector control signal of the analyzing circuitry 32 provided at a selection line 58, and, in turn, at the third link 38 in order to supply the pixel output signal selective to the analyzing circuitry 32.

A charge stored in the pixel capacitor 18 may therefore be read-out with an external Si-integrated circuit which is comprised by the analyzing circuitry 32 containing a goal CSA and an analog-digital converter (ADC), for example, for conversion to 14 or 16 bit.

Although this technology is operative, its operating speed can be considered slow and it limits a noise floor because the noise of all lines, especially, a VDD-line and datalines, such as the dataline 60, are superimposed on the read-out charges from the x-ray sensing pixel element 14 and the dynamic range generally cannot be adjusted. The respective x-ray imager system is shown in FIG. 2 with regard to the image sensor apparatus 10.

The before-mentioned technology which is based on PPS, can be replaced by a technology based on APS because APS allows an in-pixel charge amplification and therefore can result in improvement in the noise floor and in the read-out speed. With this approach the base is formed in order to attenuate a gain of the amplifier TFT which can be achieved by several different ways.

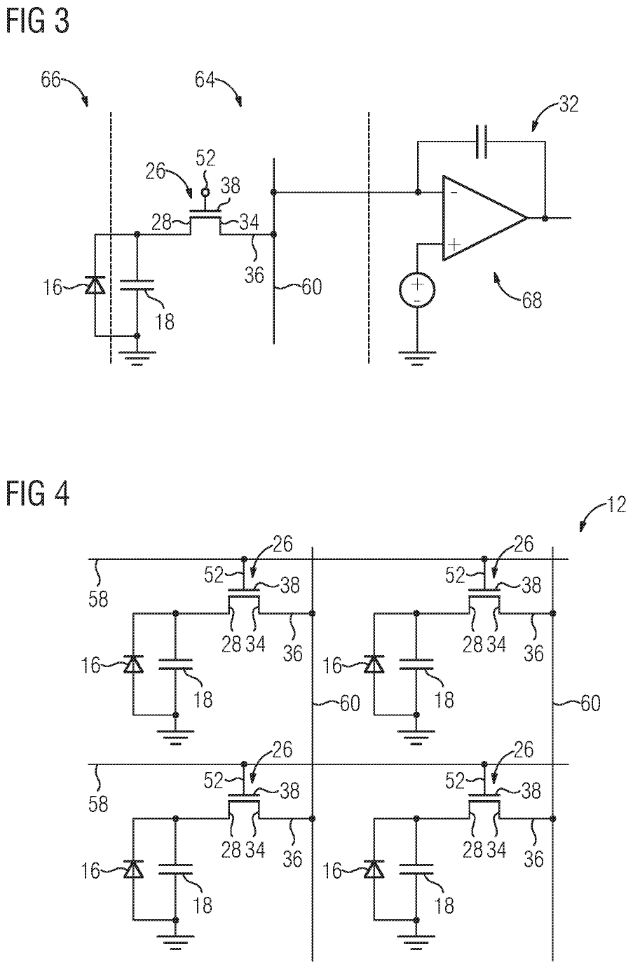

Generally, a thin-film detector such as the image sensor apparatus 10 usually comprises three parts, namely, a front plane 66, a backplane 64, and a read-out integrated circuit 68 as enclosed by the analyzing circuitry 32 (FIG. 3). The front plane 66 usually delivers a certain amount of charge depending on the sensor, which here is a photo sensor, namely, the photo diode 16. In the backplane 64, the radiation sensing pixel element 14 comprises the storage capacitor 18 and a single thin-film transistor forming the pixel selector transistor 26. The thin-film detector comprises the array 12 of radiation sensing pixel elements 14 which form a matrix of pixels as shown in FIG. 4. The dataline 60 is also comprised by the backplane 64. The dataline 60 is further connected with a read-out integrated circuit (ROIC 68) which may be provided by regular bulk semiconductor material, for example, provided in CMOS-technology. FIG. 4 shows a portion of the array 12 including radiation sensing pixel elements 14 according to FIG. 3. As depicted in FIG. 4, columns of radiation sensing pixel elements 14 are provided where the pixel output link 36 of the radiation sensing pixel elements 14 of a certain column are connected to a common dataline 60. At the same time, rows of the radiation sensing pixel elements 14 are provided where all third links 38 of the respective pixel selector transistors 26 are connected with a common selection line 58. This allows controlled read-out of each of the radiation sensing pixel elements 14.

FIG. 5 shows a schematic circuitry similar to FIG. 3.

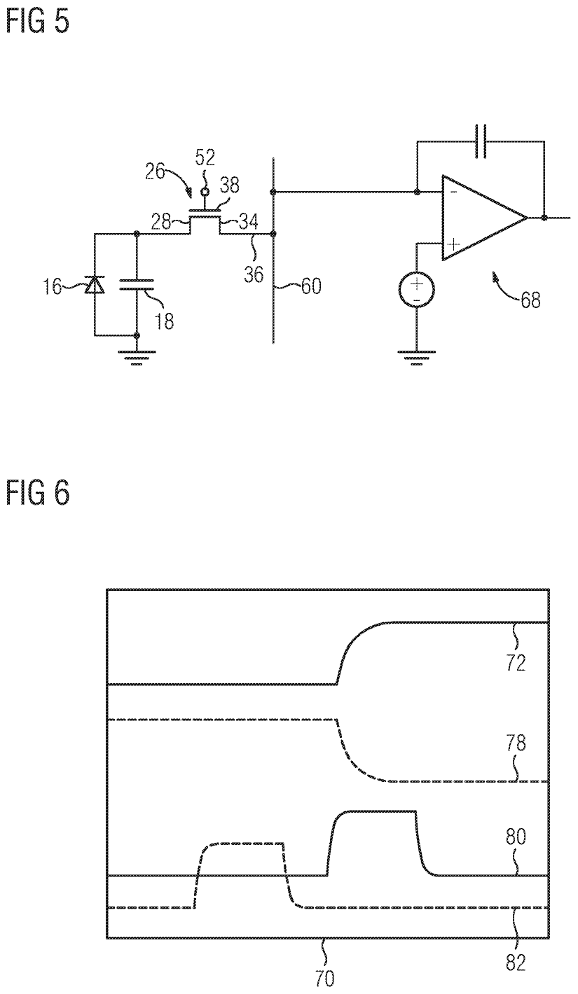

FIG. 6 shows a corresponding schematic timing diagram of signals during read-out of the radiation sensing pixel element 14 according to FIG. 5. An abscissa 70 represents a timing axis, wherein an ordinate corresponds to a certain voltage level. The diagram of FIG. 6 shows four graphs, namely, a first graph 72 representing the signaling of an output of the ROIC 68 as well as an internal signal represented by the graph 78. A graph 80 represents a select signal corresponding to a selector control signal of the analyzing circuitry 32 which acts on the third link 38 of the pixel selector transistor 26. Moreover, a reset-signal is represented by a graph 82. As can be seen from FIG. 6, all noise of the read-out is directly superimposed on the small signal coming from the radiation sensing pixel element 14 leading to a very expensive ROIC 68 and resulting in a limited dynamic range. This can be improved by using an active pixel scheme.

The use of an active pixel scheme allows an in-pixel charge amplification and therefore improves the noise floor and the readout speed. A high charge-to-current gain can be obtained. With the active pixel scheme as discussed in the present disclosure, the gain of the in-pixel amplifier TFT can be attenuated in several ways. Different approaches may be used to increase the dynamic range.

According to a first approach, one frame is imaged and a respective charge stored in the pixel capacitor 18 is read-out twice, once with a high amplification and once with a low amplification. With regard to x-ray imager, only one shot with a standard dose is necessary.

A second approach involves imaging of one frame and read-out of the charge with a maximum amplification followed by an imaging of one frame and read-out of the charge, whereby the charge amplification is locally reduced in areas, where the previous image was too bright. With respect to x-ray imagers, this could correspond to two shots, namely, a first shot with a minimum dose and a second shot with a standard dose.

A third approach involves imaging a frame, and read-out is provided with a maximum amplification followed by imaging of one frame with reduced charge amplification. With respect to an x-ray imager, this could correspond to two shots with a standard dose.

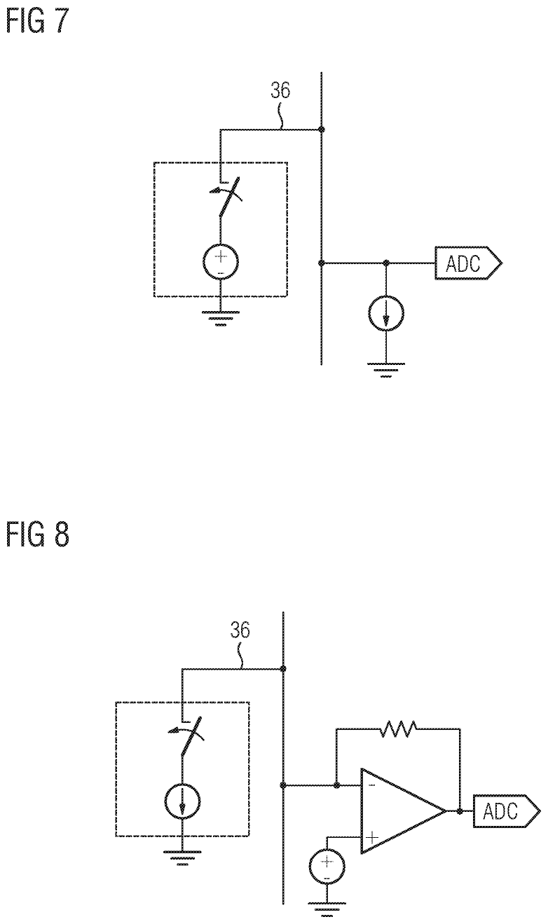

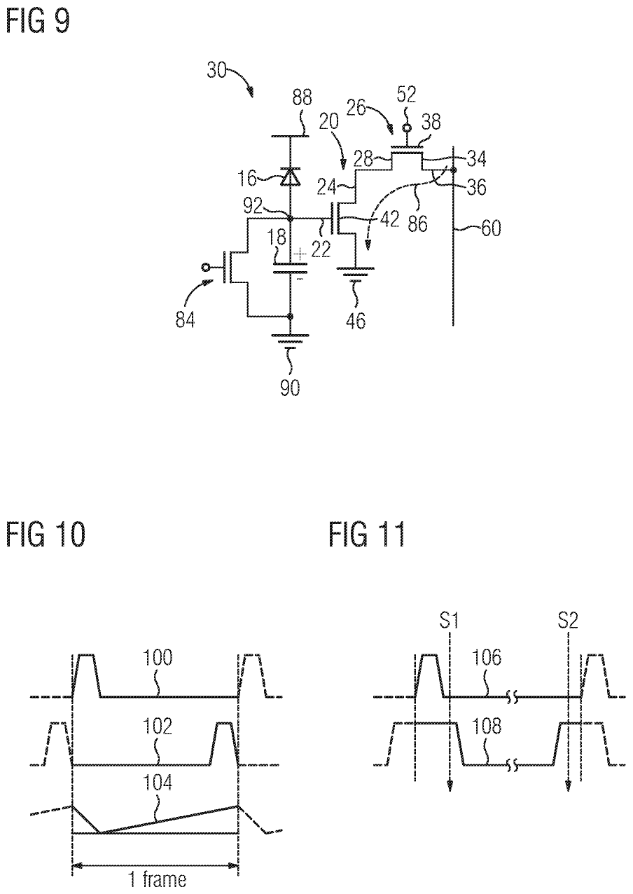

An active thin-film pixel element such as the radiation sensing pixel element 30 (FIG. 9) operates differently with regard to an active pixel for contact image sensors (CIS), in the sense that a current mode is used. This difference is shown by FIGS. 7 and 8. The current mode has at least two potential advantages in the thin-film technology compared to a voltage mode. In the voltage mode, with regard to the active pixel element 30, the dataline 60 is charged and discharged continuously because of the changing of the data. However, it should be noted that the dataline 60 represents a very large capacity, e.g., in the range of about 50 pF to a few hundred of pF, and the charging comes from low-performance transistors providing only a limited current. This results in large time constants for settling of the dataline 60. Moreover, voltage levels for column read-out by the ROIC 68 is limited usually by the CMOS-technology limit which usually is in the range of 2.5 V or 1.8 V, whereas voltages applied in the backplane 64 can be in the range of about 10 V to about 40 V. In a voltage mode, the ROIC 68 should be able to operate these large voltage ranges, but in the current mode the voltage range can be limited to a rather small voltage range, preferably to a voltage range or voltage swing on the dataline of about 0 V. Consequently, the use of the current mode allows additional features which were typically difficult to realize in a voltage mode or which are not possible to be realized in a voltage mode. Therefore, an embodiment of the disclosure involves the unique properties of the current mode read-out in thin-film-technologies in order to improve the system that is the image sensor apparatus 10, to high dynamic range (HDR).

An active pixel sensor such as the radiation sensing pixel element 30 (FIGS. 9, 12, 18) amplification of the signal within the array 12, and then the pixel output signal is forwarded to the analyzing circuitry 32. The current mode involves the charges being integrated and stored in a capacitor and converted to a voltage. This voltage is used as a gate voltage for a common source or source degenerated amplifier such as the amplifier 20, with both of them generating a current. This current is read-out by the ROIC 68. An exemplary embodiment for a common source amplifier 20 is shown in FIG. 9. In this embodiment, the amplifier 20 comprises a MOSFET.

FIG. 9 shows an exemplary embodiment of the radiation sensing pixel element 30 operating as an active pixel element in a current mode. The schematic circuitry according to FIG. 9 has a photo diode 16 which is connected with the pixel capacitor 18 in series connection with an electric reference potential 90 and an electric application potential 88 which may cause a voltage in a range of about 10 volt to about 40 volt. However, depending on the characteristics of the photo diode 16 and the direct radiation to be sensed, this voltage can be chosen differently.

When the photo diode 16 is subjected to prospective radiation, the photo diode 16 provides a respective electric current which is accumulated in the pixel capacitor 18. Therefore, the pixel capacitor 18 stores electric charge dependent on the amount of radiation acting on the photo diode 16. At a connecting point 92 between the photo diode 16 and the pixel capacitor 18, the pixel amplifier 20 is connected. Presently, the pixel amplifier 20 comprises an amplification transistor 42 which is presently formed by a MOSFET. A gate of the MOSFET 42 forms an input link 22 that is connected with the connecting point 92. A source of the MOSFET 42 is connected with a ground level 46. The ground level 46 has a different electric potential as the reference 90. However, in other embodiments, these electric potentials can be the same. A drain of the MOSFET 42 forms an output link 24 which is connected with a first link 28 of a pixel selector transistor 26. The pixel selector transistor 26 is presently also formed by a MOSFET. A second link 34, presently the drain of the MOSFET 26, forms a pixel output link 36, which in turn is connected with the dataline 60. The dataline 60 connects the radiation sensing pixel element 30 with the analyzing circuitry 32 as described above.

Moreover, the MOSFET 26 has a third link 38 which is formed by its gate, and which forms a connecting link 52 which in turn is connected with a selection line 58 as described above. Moreover, a reset switch 84 is provided which is also formed by a MOSFET. The reset switch 84 serves to discharge the pixel capacitor 18 after having read-out its charge status. The reset switch 84 is triggered by a respective reset signal which is provided also by the analyzing circuitry 32. The operating mechanism of the radiation sensing pixel element 30 according to FIG. 9 is further detailed with regard to FIGS. 10 and 11.

FIG. 10 shows three signals in a schematic time diagram, namely the reset signal 100, a select signal 102, and an internal signal 104 at the connecting point 92 with reference to one single frame. Generally, it can be derived from FIG. 10 that, when the select signal 102 is present, a current 86 is flowing from or to the ROIC 68. The reset signal 100 according to FIG. 10 is acting on the reset switch 84. If the reset signal 100 has a high value, the pixel capacitor 18 is discharged. When the reset signal 100 has a low value, the reset switch 84 is in its open status so that charging of the pixel capacitor 18 is not affected. The internal signal 104, which represents the voltage at the connecting point 92, increases because the photo diode 16 supplies electric charge to the pixel capacitor 18 in response to being subjected to prospective radiation. After a certain time, which is determined by the frame timing as indicated in FIG. 10, the select signal 102 which acts on the third link of the MOSFET 26 changes to the high level. While the select signal 102 having a high level, the current 86 is flowing. This allows read-out of the electric charge of the pixel capacitor 18 because the value of the current depends on the amount of charge stored by the pixel capacitor 18. If the select signal has changed to the low level, the MOSFET 26 switches into a switched-off state so that the current 86 does not further flow. After finishing read-out by the select signal 102, the reset signal 100 is provided in order to discharge the pixel capacitor 18 so that it is prepared for a further measurement in a consecutive frame.

FIG. 11 shows two read-outs during one single frame. FIG. 11 shows the reset signal 106 according to the reset signal 100 of FIG. 10. However, the select signal 108 is deferring. The other conditions generally conform to the previous embodiment according to FIG. 10. As can be seen from FIG. 11, there are two possibilities for read-out of the radiation sensing pixel element 30, namely, at the time positions S₁ and S₂. As the time position S₁ is shortly after the reset signal 106 reaches its low level and the time position S₂ is just before the reset signal 106 changes to the high level, it is possible to read-out the radiation sensing pixel element 30 at two different times within a single frame where the electric charge stored by the pixel capacitor 18 is deferring. Only one shot is necessary.

At the timestamp S₁, the electric charge is rather low with regard to the time stamp S₂. This allows improving the dynamic range because if the photo diode 16 is exposed to a high radiation density, it provides high charging of the pixel capacitor 18. If the charge increases too much, the amplifier 20 may get into saturation so that the dynamic range of the radiation sensing pixel element 30 is limited. However, the timestamp S₁ allows read-out of the radiation sensing pixel element 30 early enough before the pixel amplifier 20 reaches saturation so that the dynamic range can be improved.

So, the dynamic range of the radiation sensing pixel element 30 can be increased without needing two different measurements with different sensitivities of the sensor, e.g. with regard to X-ray, without needing two X-ray shots with a different dose.

One possibility to increase the dynamic range is rescaling an input-to-output conversion rate or gain. For reducing a lower limit, the noise can be reduced, and the conversion gain should be large. For larger input values, the conversion gain could be reduced. Generally, the input-to-output conversion rate, which is presently a charge-to-current gain, (CtC-gain), can be adjusted in four ways. The CtC-gain can be described as

G_{CTC}=g_{m,amp}/Cₛₜₒᵣₑ

wherein g_{m,amp} is the transconductance of the amplification transistor 42 and Cₛₜₒᵣₑ is the charge stored on the pixel capacitor 18. Therefore, gₘ of the amplification transistor 42 should be controlled, for example, reduced. Generally, the following options are possible in order to affect an amplification factor such as gₘ:

1. Reducing a voltage on the dataline 60. This means that the amplification transistor 42 can be pushed from the saturation regime in a linear regime. The total current output can then be reduced linearly by changing the voltage on the data line 60.

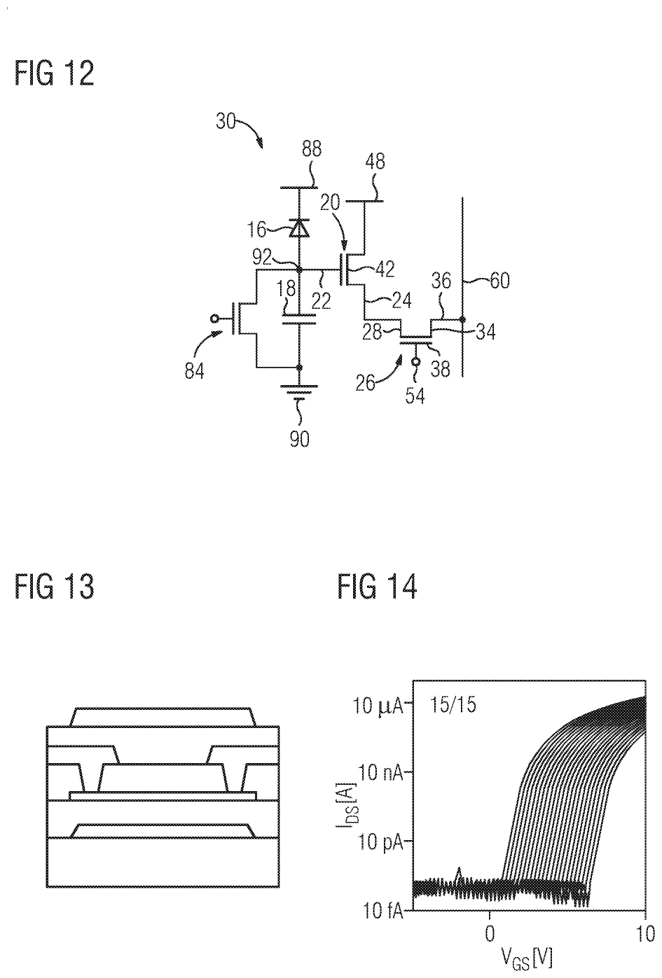

2. With regard to a source-degenerated topology which is further detailed with regard to FIG. 12, it is possible to reduce the gain of the amplification transistor 42 by changing the value of a degeneration resistor R according to the equation

g_{m,eff}=gₘ/(1+gₘR)

In this embodiment, the degeneration resistor is provided by the pixel selector transistor 26. By changing an applied on-voltage for the selected switching the value of the degeneration resistor can be changed. As can be seen from FIG. 12, the resistance caused by the pixel selector transistor 26 acts on the amplification transistor 42 as a feedback operation so that the gain can be controlled by the resistance provided by the pixel selector transistor 26. In order to allow such operation, the pixel selector transistor 26 is not only operated in the switch mode, but it is now also operated partially in a linear mode. The linear mode is effective during read-out, wherein the switch mode, especially, the switched-off-state remains not affected. In this regard, by controlling the select signal, especially during a switched-on-status, the gain of the radiation sensing pixel element 30 can be controlled. The amplification transistor 42 is further connected with a supply voltage V_{dd} indicated by reference character 48.

3. The ground level 46 of the pixel amplifier 20 according to FIG. 9 can be used in order to control the gain. If the ground level 46 of the pixel amplifier 20 increases, then V_{G}-V_{S}-V_{T} of the amplification transistor 42 decreases as well resulting in less current and in turn a smaller CtC-gain.

4. A further approach to control the gain is that an amplification transistor 44 is provided that has two control electrodes, in the case of a MOSFET, a dual-gate MOSFET. This allows using one of the dual gates to control an operating point of the amplification transistor 44 and the other of the dual-gate to provide amplification according to the charge stored in the pixel capacitor 18. A layer structure of such a dual-gate MOSFET 44 is shown in FIG. 13. FIG. 14 shows a schematic diagram with a plurality of graphs which correspond to deferring voltage levels of the second gate of the dual-gate MOSFET 44. The graphs depicted in the diagram correspond to a voltage at the first gate. As can be seen from the diagram, deferring the voltage at the second gate leads to move the graph in a direction of the abscissa. The abscissa represents a gate-to-source voltage of the MOSFET 44, wherein the ordinate corresponds to a drain-source current. Therefore, with the second gate, a threshold voltage of this transistor 44 can be changed. The resultant effect could be rather similar to raising the ground level 46 of the amplification transistor 42 as previously mentioned. The amplification transistor 44 is further connected with a supply voltage V_{dd} indicated by reference character 48.

All of the previously discussed approaches are generally possible within thin-firm sensor arrays such as the array 12, especially with regard to a specific system using assembly with a thin-film backplane 64, silicon ROIC's and some general interface circuitry which may contain field programmable gate arrays, FPGA, DC/DC's, voltage transformers, etc.

Voltage sources for a panel ground, a reference, on and off values for the pixel selector transistor 26, and the like can all be set externally and freely. This is a potential advantage with regard to CIS, where all periphery components are generally generated in the same technology as a matrix and voltages greater than a supply voltage are difficult for use.

Another potential advantage of the disclosure is that a voltage range at the internal connection 92 can be quite large, as this is provided in the thin-film-technology which, e.g., may have a supply voltage in a range between about 10 volts and about 20 volts. So, the voltage at the cathode of the photo diode 16 can be quite high. Charges are therefore still extracted even if the internal connection 92 raises by e.g. 10 volts. This is generally not the case in CIS technology, where the cathode voltage of the photo diode 16 can be limited to the supply voltage VDD of the technology which is usually in a range between about 1 volt and about 2.5 volts.

All previously discussed approaches effectively allow controlling the CtC-gain of the radiation sensing pixel element 30, thereby allowing increasing the maximum input signal that can be read-out by the ROIC 68. It should be noted that for optimal charge-to-current conversion, the amplification transistor 42, 44, is biased in saturation, but it does not need to operate there. It may also operate in a linear mode.

With respect to the ROIC 68, two approaches can be followed in order to achieve a HDR read-out. Usually, the ROIC 68 is correlated double sampling (CDS) in order to eliminate many sources of noise, both in the ROIC 68 as well as in the backplane 64. This can be achieved by use of an APS, since the backplane 64 typically cannot be calibrated with PPS. A CDS measurement requires a double measurement with respect to signal and reset value which is usually subtracted in an analog fashion which is depicted in FIG. 15. Since an HDR requires two samples, e.g. one with a high sensitivity and one with a low sensitivity, a typical ROIC 68 generally cannot do this with one shot only. The reason is that the signal is read-out and the internal value is, in turn, immediately destroyed by the reset, in the case of CDS. In order to avoid this, two operations could be performed:

1. A double pulse can be provided and read-out with deferring amplification settings, e. g., amplification factors.

2. A more complex ROIC can be provided that is adapted to measure with a high sensitivity, store, measure with a low sensitivity and store, and measure the reset value, and, thereafter, both, high and low sensitivity measurements can be converted using CDS. FIG. 16 shows a respective concept in a schematic diagram. Therefore, this concept can allow using only one single shot with minimum radiation dose. This corresponds to the previous mentioned first option to increase the dynamic range. FIG. 16 depicts how the different read-outs are connected with each other in view of timing. A lower schematic circuitry shows a corresponding adaptation in order to achieve this kind of read-out applied to the circuitry according to FIG. 15. FIGS. 15 and 16 are therefore comprised by the analyzing circuitry 32.

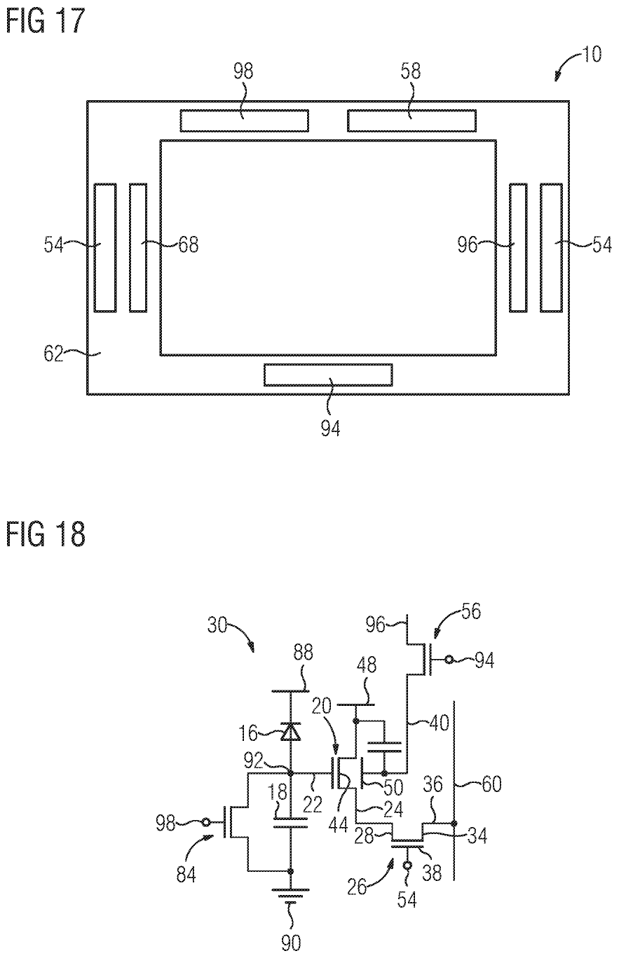

FIG. 17 shows a block diagram for an imager system implementation for a read-out scheme according to option 2 as mentioned above. A possible implementation of the second option of the read-out scheme using a dual-gate TFT such as the MOSFET 44, or for adjusting amplification or gain, respectively, is described with reference to FIGS. 17 and 18.

FIG. 17 shows an image sensor apparatus 10 which is adapted for use for a read-out scheme according to the second option. The image sensor apparatus 10 is based on the apparatus which is previously described with regard to FIG. 2. On the framework 62 is provided the ROIC 68 as well as a gate driver vbgselect 94, a gate driver reset 98, as well as a vbackgate 96. A corresponding radiation sensing pixel element 30 is shown in FIG. 18. Generally, the circuitry of this radiation sensing pixel element 30 is based on the radiation sensing pixel element 30 according to FIG. 12.

Differing from the embodiment of FIG. 12, the amplification transistor 42 is here replaced by an amplification transistor 44 which was already discussed with regard to FIGS. 13 and 14. The amplification transistor 44 is provided by a dual-gate MOSFET. With regard to the amplification transistor 42 of the FIG. 12, the amplification transistor 44 of FIG. 18 has a second gate 50 which is connected to a gain control link 40. The gain control link 40 is connected with a further transistor 56, which in this embodiment is also a MOSFET. A gate of the transistor 56 is connected to vbgselect 94. A drain of the transistor 56 is connected to vbackgate 96. A source of the transistor 56 is connected to the gain control link 40.

With the signaling vbgselect 94 the time scheme for acting the gain control signal on the amplification transistor 44 can be predetermined. The signal vbackgate 96 allows for adjusting an electric potential of the gate 50 of the MOSFET 44 in order to adjust its gain as indicated according to FIG. 14. So, it is possible for the analyzing circuitry 32 to control the gain of each single radiation sensing pixel element 30 that is connected with the analyzing circuitry 32. The gate driver reset 98 produces a reset signal which is supplied to the reset switch 84 in order to establish a predetermined reset operation. The gate driver select 58 acts on the pixel selector transistor 26, namely, a respective link 52. The further details of operation correspond to the previous embodiments.

In a frame, in which the vbgselect 94 is activated, the vbackgate 96 sets a uniform maximum amplification factor across the imager by re-setting a threshold voltage of the amplification transistor (TFT) 20 to a more negative value.

Next, the imager is read-out.

Then, in a frame in which the vbgselect 94 is activated, the vbackgate 96 is set with a local specific amplification depending on the image recorded in the previous frame. The amplification is adjusted locally by re-setting the threshold voltage of the amplification transistor (TFT) 44 to a more positive value for areas that need a reduced amplification.

Next, the final image is read-out.

With a traditional X-ray imager, the imager can take an image twice, once with a low power and once with a high power. The disadvantage is that a high power and therefore a higher dose should be avoided. Moreover, this approach does not allow increasing the dynamic range by more than a factor of about 3 to 5, since the size of the integration capacitor is generally fixed. Additionally, the speed of reading-out of traditional imagers is very low, usually in a range of 3 to about 4 Hz partly because of RC delay in long datalines and partly because of the need to make multiplexing in the Si-ROIC for cost reasons. Additionally, each data line might not have a separate CSA and ADC. Finally, overlaying by computation of two images might cause image blur, since a patient and/or organs in the patient can move between capturing the two images.

Also, if a traditional X-ray imager makes two images, one image with a short pulse and one image with a long pulse, the speed of the frames will typically need to be adjusted. The disadvantage is that the long pulse increases the dose. Moreover, the speed of the imager and the CSA-IC cannot be adjusted easily over orders of magnitude. The size of the integration capacitor is generally fixed. Additionally, the speed for reading out is very slow as mentioned before. Finally, overlaying by computation of the two images may also cause image blur, as discussed before. The same disadvantages appear when an adjustable pixel capacitor is used.

The disclosed concepts help overcome these disadvantages by allowing a dynamic range of about one to three orders of magnitude. Moreover, only one X-ray source with the same power and pulse length may be necessary to be used. The increase in range is not only caused by increasing the upper range but also by lowering the noise floor as long as the noise floor is not already set by the shot noise and off-current of the photo diode 16. Consequently, a large area thin-film imager can be improved. So it is possible that a large area imager can be e.g. a palm reader.

If desired, the different functions and embodiments discussed herein may be performed in different or deviating order in various ways. Furthermore, if desired, one or more of the above-described functions and/or embodiments may be optional or may be combined.

Also various aspects of the disclosure are set out in the independent claims, but other aspects of the disclosure comprise other combinations of features from the described embodiments and/or the dependent claims with the features of the independent claims, and not solely the combinations explicitly set out in the claims.

It is also observed that, while the above describes exemplary embodiments of the disclosure, this description should not be regarded as limiting the scope. Rather, there are several variations and modifications which may be made without departing from the scope of the present disclosure as defined in the appended claims.

Finally, the advantages and effects as discussed with respect to the radiation sensing pixel element can also be applied to the image sensor apparatus and the method as well. Especially, it is possible to transform apparatus features to method features and vice-versa.

While some embodiments have been illustrated and described in detail in the appended drawings and the foregoing description, such illustration and description are to be considered illustrative and not restrictive. Other variations to the disclosed embodiments can be understood and effected in practicing the claims, from a study of the drawings, the disclosure, and the appended claims. The mere fact that certain measures or features are recited in mutually different dependent claims does not indicate that a combination of these measures or features cannot be used. Any reference signs in the claims should not be construed as limiting the scope.

1-14. (canceled)

15. A radiation sensing pixel element for an image sensor apparatus having an array of radiation sensing pixel elements, wherein the radiation sensing pixel element comprises:
a photo diode configured to sense radiation;
a pixel capacitor electrically coupled to the photo diode such that the pixel capacitor is configured to store electric charge generated by the photo diode in response to the photo diode being subjected to the radiation;
a pixel amplifier having (i) an input link electrically coupled to the pixel capacitor and (ii) an output link, wherein the pixel amplifier is configured to provide a pixel amplifier output signal at the output link that is dependent on an amount of the electric charge stored in the pixel capacitor; and
a pixel selector transistor having a first link, a second link, and a third link, wherein the first link is electrically coupled to the output link of the pixel amplifier and the second link is adapted to be electrically coupled to an analyzing circuitry of the image sensor apparatus, wherein the pixel selector transistor is configured to provide a pixel output signal at the second link that is dependent on the pixel amplifier output signal and a selector control signal of the analyzing circuitry provided at the third link,
wherein the radiation sensing pixel element is configured to control a gain defining a dependency between the pixel output signal and the amount of the electric charge stored in the pixel capacitor.

16. The radiation sensing pixel element according to claim 15, wherein the radiation sensing pixel element is configured to provide an electric current as the pixel output signal.

17. The radiation sensing pixel element according to claim 15, further comprising a gain control link configured to receive a gain control signal.

18. The radiation sensing pixel element according to claim 17, wherein the pixel amplifier is electrically coupled to the gain control link and is configured to adjust an amplification factor based on the gain control signal.

19. The radiation sensing pixel element according to claim 17, wherein the pixel amplifier comprises an amplification transistor.

20. The radiation sensing pixel element according to claim 19, wherein the pixel amplifier is configured to control a first operating point of the amplification transistor, dependent on the gain control signal.

21. The radiation sensing pixel element according to claim 20, wherein the amplification transistor has a separate control electrode which the gain control signal can act on to control the first operating point.

22. The radiation sensing pixel element according to claim 20, wherein the pixel output signal is formed by electric current and the radiation sensing pixel element is configured to control the first operating point of the amplification transistor by a voltage supplied to the second link.

23. The radiation sensing pixel element according to claim 20, wherein the pixel selector transistor is configured to be operated at least partially in a linear operating mode in response to the gain control signal.

24. The radiation sensing pixel element according to claim 23, wherein the pixel selector transistor is electrically coupled to the amplification transistor such that the first operating point of the amplification transistor can be controlled by the pixel selector transistor.

25. The radiation sensing pixel element according to claim 23, characterized in that the radiation sensing pixel element is configured to adjust a second operating point of the pixel selector transistor based on the gain control signal.

26. The radiation sensing pixel element according to claim 15, characterized in that the pixel amplifier is electrically coupled to a ground level that is provided by the radiation sensing pixel element, wherein an electric potential of the ground level can be controlled by a gain control signal, and wherein the pixel amplifier is configured to adjust an amplification factor dependent on the electric potential of the ground level.

27. An image sensor apparatus including an array of radiation sensing pixel elements and an analyzing circuitry for analyzing pixel output signals of the radiation sensing pixel elements, wherein the analyzing circuitry is connected with the array of the radiation sensing pixel elements, and wherein the array comprises radiation sensing pixel elements according to claim 15.

28. A method for operating a radiation sensing pixel element of an array of radiation sensing pixel elements of an image sensor apparatus, wherein the method comprises:
sensing radiation with a photo diode;
storing, in a pixel capacitor electrically coupled to the photo diode, electric charge supplied by the photo diode in response to the sensed radiation;
providing a pixel amplifier output signal at an output link of a pixel amplifier having an input link electrically coupled to the pixel capacitor, wherein the pixel amplifier output signal depends on an amount of the electric charge stored in the pixel capacitor;
providing, to analyzing circuitry of the image sensor apparatus, a pixel output signal at a pixel output link of the radiation sensing pixel element by a pixel selector transistor, the pixel output signal being dependent on the pixel amplifier output signal and a selector control signal provided by the analyzing circuitry; and
controlling a gain defining a dependency between the pixel output signal and the amount of the electric charge stored in the pixel capacitor.

29. The method of claim 28, wherein providing the pixel output signal comprises providing an electric current.

30. The method of claim 28, wherein controlling the gain comprises providing a gain control signal to a gain control link of the image sensor apparatus.

31. The method of claim 30, further comprising adjusting an amplification factor based on the gain control signal.

32. The method of claim 30, further comprising controlling a first operating point of an amplification transistor of the image sensor apparatus based on the gain control signal.

33. The method of claim 32, further comprising controlling the first operating point by providing the gain control signal to a control electrode of the amplification transistor.

34. The method of claim 32, further comprising controlling the first operating point of the amplification transistor by providing a voltage.
